(19) United States
(12) Patent Application Publication
(10) Pub. No.: US 2024/0418005 A1
(43) Pub. Date: Dec. 19, 2024

(54) LOCK AND LOCKING METHOD

(71) Applicant: FULLYEAR-BROTHER ENTERPRISE CO., LTD., CHANGHUA COUNTY (TW)

(72) Inventor: Chun Te YU, CHANGHUA COUNTY (TW)

(21) Appl. No.: 18/491,253

(22) Filed: Oct. 20, 2023

(30) Foreign Application Priority Data
Jun. 14, 2023 (TW) 112122259

(51) Int. Cl. E05B 37/02; E05B 37/00; E05B 53/00

(52) U.S. Cl. CPC E05B 37/025; E05B 37/0031; E05B 53/003

(57) ABSTRACT

A lock includes a housing, a first lock member, a second lock member and a control member. One end of the first lock member is fixed with the housing and the other end is connected with a first block. One end of the second lock member is connected with a second block and the other end is connected with the control member. The control member is fixed in a first position when in a non-movable state, and in the meantime the first block and the second block are horizontally aligned. The control member is capable of moving between the first position and a second position when in a movable state, and in the meantime the second lock member is pulled by the control member away from the first block.

### BACKGROUND OF INVENTION

### 1. Field of Invention

The present invention relates to a lock and, more particularly, to a lock and a locking method applied for an object with a hole.

### 2. Related Prior Art

Conventional lock, such as disclosed in Taiwan Patent publication Nos.517753, 253442, 273844, 1434984 and China Patent publication No. CN201056894Y, commonly includes a lock body with a U-shaped bar or a flexible cable. One end of the bar or the cable is always secured to the lock body while the other end is able to temporarily separate from the lock body and further resume connection after the bar or the cable passing through an object so as to lock the object.

### SUMMARY OF INVENTION

The present invention provides a new locking method applied to an object with a through hole which is different from the previous conventional locks. Firstly, put a first strip and a second strip through the through hole. One end of the first strip is coupled to a first block while another end is fixed. One end of the second strip is coupled to a second block while another end is controllable to pull the second strip and the second block. Each diameter of the first block and the second block is less than a diameter of the through hole, but a total width of the first block and the second block that are horizontally aligned is greater than the diameter of the through hole. The object could be locked by pulling the second strip to move the second block to horizontally align with the first block and then fastening the second strip. On the other hand, the object could be unlocked by pulling the second strip to stagger the first block and the second block.

The present invention further provides a lock includes a housing, a first lock member, a second lock member and a control member. One end of the first lock member is secured to the housing while another end is provided with a first block. One end of the second lock member is provided with a second block. The control member is disposed in the housing and is coupled to the second lock member. When the control member is selectively in a non-movable state, the control member is fixed in a first position and the second block is horizontally aligned with the first block. When the control member is selectively in a movable state, the control member is capable of moving between the first position and a second position so as to stagger the first block and the second block.

In one embodiment, the control member includes a lock mechanism. The control member is fixed in the first position if the lock mechanism is locked. The control is movable between the first position and the second position if the lock mechanism is unlocked.

In another embodiment, the control member includes a first lock module and a second lock module coupled with each other. The first lock module which is unlocked is movable between the first position and the second position. The first lock module which is locked is restrained by the second lock module to be fixed in the first position if the second lock module is locked. The first lock module is movable between the first position and the second position if the second lock module is unlocked.

Furthermore, a first shifting member and a second shifting member are disposed between the first lock module and the second lock module. A wedge portion of the first shifting member is movably engaged with a wedge portion of the second shifting member. The second shifting member is fixed when the second lock module is locked. A mobility of the first shifting member is restrained by the first lock module and the second shifting member so that the first lock module is positioned in the first position if the first lock module is locked. The first shifting member is capable of moving relative to the second shifting member so that the first lock module is capable of moving between the first position and the second position if the first lock module is unlocked. The second shifting member is capable of moving relative to the first shifting member so that the first lock module is capable of moving between the first position and the second position if the second lock module is unlocked.

Preferably, the first lock module is a combination lock or a key lock, and the second lock module is a combination lock or a key lock.

Preferably, the first lock member includes a first strip with one end secured to the housing and another end sticking out of the housing to connect to the first block. The second lock member includes a second strip with one end coupled to the control member and another end sticking out of the housing to connect to the second block.

Preferably, both of the first strip and the second strip are flexible, and parts of both of the first strip and the second strip which stick out of the housing are covered by a sleeve. Each of the first block and the second block cannot pass through the sleeve.

Preferably, the housing is provided with a hook portion to be engaged with the control member and forming a loop when the control member is located in the first position.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a flowchart of the locking method according to the present invention;

FIGS. 2 and 3 are simple diagrams showing the execution of the locking method according to the present invention;

FIG. 4 is a perspective view of the lock according to the present invention;

FIG. 5 is a perspective exploded view of the lock according to the present invention;

FIG. 6 is a cross-sectional view of the lock in a locked state;

FIG. 7 is a cross-sectional view of the lock in a first unlocked state;

FIG. 8 is a cross-sectional view of the lock in a second unlocked state;

FIG. 9 shows how the lock is applied to a suitcase.

### DETAILED DESCRIPTION OF PREFERRED EMBODIMENT

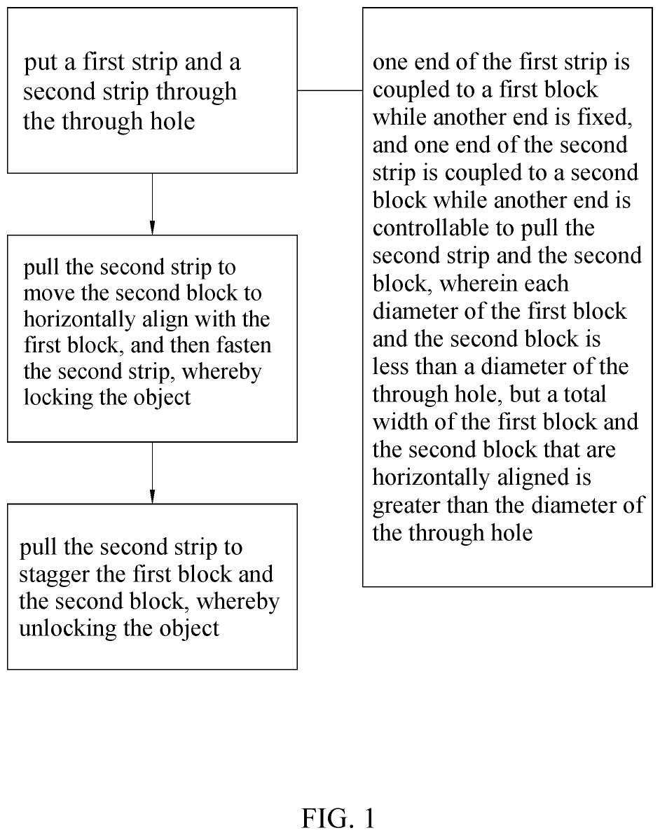

FIG. 1 discloses a locking method according to the present invention. This method is applied to an object with a through hole, including:
putting a first strip and a second strip through the through hole;
pulling the second strip to move the second block to horizontally align with the first block and then fastening the second strip, whereby locking the object; and
pulling the second strip to stagger the first block and the second block, whereby unlocking the object.

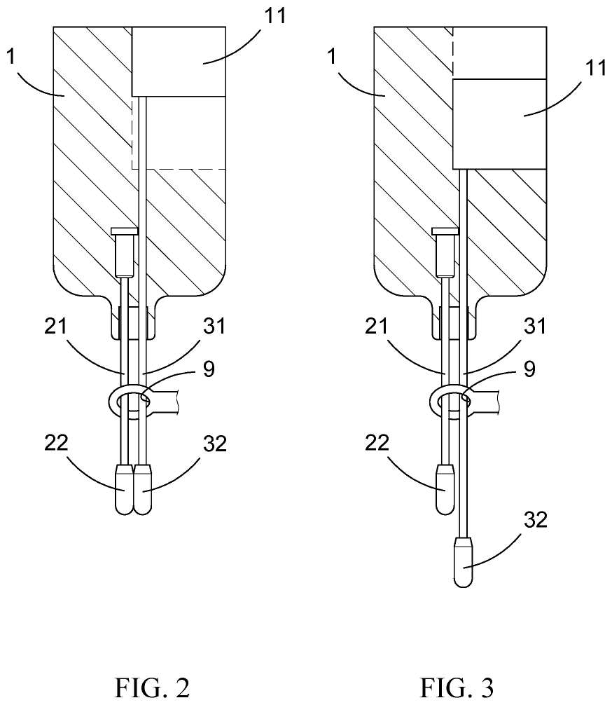

FIGS. 2 and 3 illustrate a simple diagram corresponding to a lock structure for describing the locking method. One end of the first strip 21 is fixed in a housing 1 while another end sticks out of the housing 1 and coupled to a first block 22. One end of the second strip 31 is coupled to a control member 11 disposed in the housing 1 while another end sticks out of the housing 1 and coupled to a second block 32. The control member 11 can move and can be fixed in the housing 1. With the second strip 31 being connected to the control member 11 and the second block 32, the second block 32 is pulled by the second strip 31 when the control member 11 moves, so that the position of the second block 32 changes when the position of the control member 11 changes.

Each diameter of the first block 22 and the second block 32 is less than the diameter of the through hole 9 so that the first block 22 and the second block 32 can pass through the through hole 9 separately. However, a total width of the first block 22 and the second block 32 that are horizontally aligned is greater than the diameter of the through hole 9 so that the first block 22 and the second block 32 cannot pass through the through hole 9 together.

According to the above-mentioned structure, it is possible to switch the locking state of the object by operating the control member 11 after putting the first strip 21 and the second strip 31 through the through hole 9. Referring to FIG. 2, move the control member 11 to a first position where the second block 32 is pulled by the second strip 31 to horizontally align with the first block 22 and then secure the control member 11 in the first position, and thus the second block 32 is positioned. Since the first block 22 and the second block 32 cannot pass through the through hole 9 together, the object cannot move away from the lock, thus forming a locking state.

Referring to FIG. 3, move the control member 11 to a second position where the second block 32 is pulled by the second strip 31 to be staggered from the first block 22, and thus the first block 22 and the second block 32 can pass through the through hole 9 one after another so that the object can be detached from the lock.

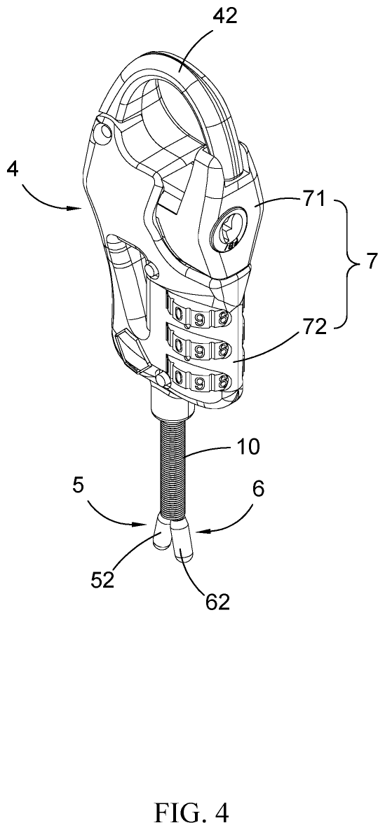

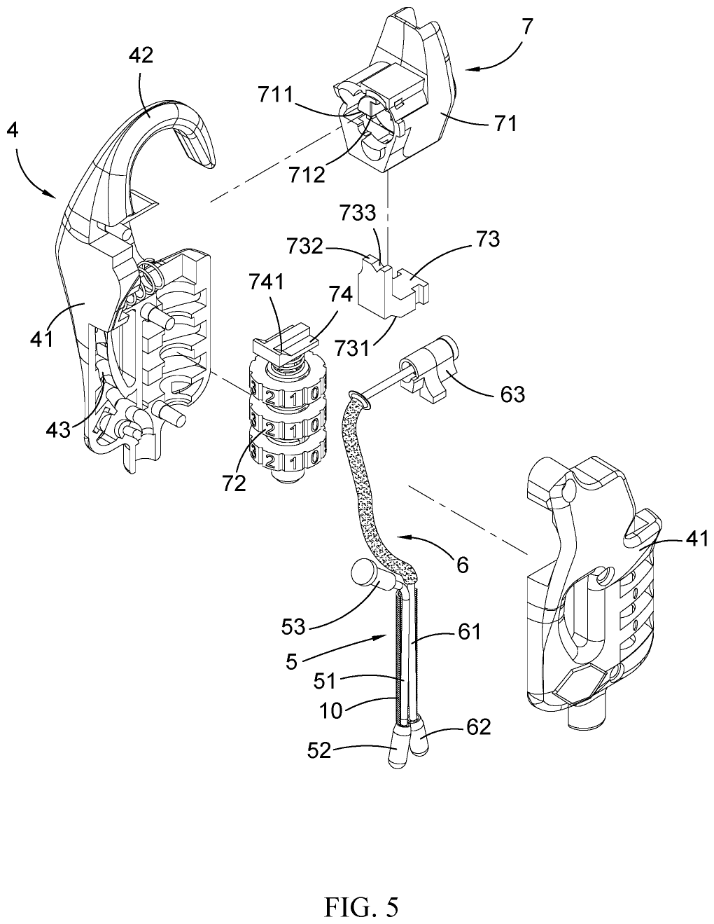

As shown in FIGS. 4 to 6, the lock according to the present invention applying the previous locking method includes a housing 4, a first lock member 5, a second lock member 6 and a control member 7. The housing 4 is composed of two shells 41 coupled together which enclose an inner space for accommodating the first lock member 5, the second lock member 6 and the control member 7. In this embodiment, a hook portion 42 is disposed at a side of the housing 4.

The first lock member 5 includes a first strip 51 with one end provided with a fixed block 53 and another end provided with a first block 52. The fixed block 53 is inserted into a slot 43 of the housing 4 to be secured in the housing 4. The first strip 51 sticks out of the housing 4 and is connected to the first block 52. The diameter of the first block 52 is greater than that of the first strip 51 but less than that of the through hole 9 so that the first block 52 can pass through the through hole 9 alone.

The second lock member 6 includes a second strip 61 with one end provided with a connecting block 63 and another end provided with a second block 62. The connecting block 63 is coupled to the control member 7. The second strip 61 sticks out of the housing 4 and is connected to the second block 62. The diameter of the second block 62 is greater than that of the second strip 61 but less than that of the through hole 9 so that the second block 62 can pass through the through hole 9 alone.

Although the first block 52 and the second block 62 can pass through the through hole 9 separately, they are unable to pass through the through hole 9 together because the total width of the first block 52 and the second block 62 that are horizontally aligned is greater than diameter of the through hole 9.

Each of the first block 52 and the second block 62 may be a hard object having no flexibility or a flexible cable. In the case of flexible cable, it is necessary to cover the parts of the first strip 51 and the second strip 61 which stick out of the housing 4 with a sleeve 10, the sleeve 10 being a spring in this embodiment. The first block 52 and the second block 62 cannot pass through the sleeve 10 separately.

The control member 7 is disposed in a compartment of the housing 4 where a first position and a second position are defined. The control member 7 can be fixed in the first position and can also move between the first position and the second position. The control member 7 may be a lock mechanism for being fixed in the first position when locked and for moving between the first position and the second position when unlocked. The second block 62 pulled by the second strip 61 comes to a side of the first block 52 to be horizontally aligned if the control member 7 is in the first position. The second block 62 pulled by the second strip 61 leaves away from the first block 52 to be staggered if the control member 7 is in the second position.

The control member 7 includes a first lock module 71 and a second lock module 72, each may be a combination lock or a key lock. In this embodiment, the first lock module 71 is a key lock while the second lock module 72 is a combination lock. The first lock module 71 and the second lock module 72 respectively generate different motions according to the locking state thereof, thus determining whether the second block 62 can be pulled.

The first lock module 71 is located above the second lock module 72. A first shifting member 73 with a wedge portion 731, along with a second shifting member 74 with a wedge portion 741, are disposed between the first lock module 71 and the second lock module 72. The second shifting member 74 is coupled to the second lock module 72, and the wedge portion 731 is movably engaged with the wedge portion 741. A sector-shaped lock core of the first lock module 71 is provided with a flat plane 711 and a corner 712. On the other hand, the first shifting member 73 is provided with a top surface 732 and a recess 733 complementary to the shape of the corner 712.

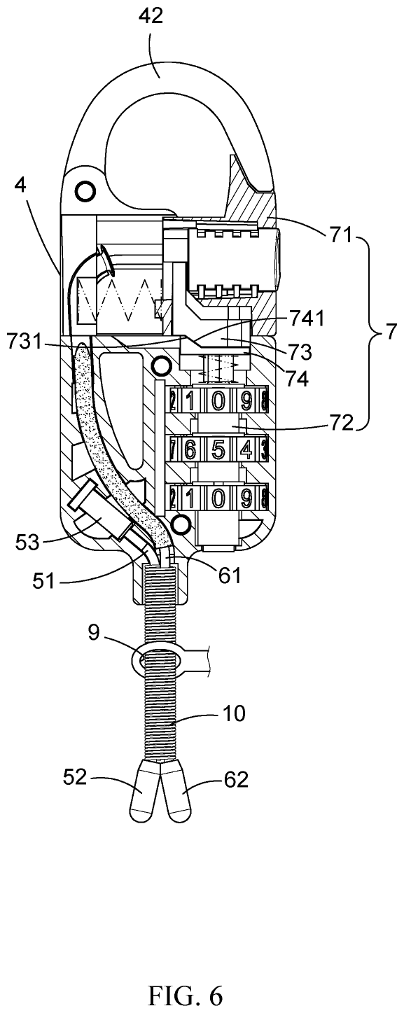

According to the above-mentioned structure, the second shifting member 74 is fixed if the second lock module 72 is locked. In this case, referring to FIG. 6, if the first lock module 71 is locked, the flat plane 711 of the first lock module 71 abuts against the top surface 732 of the first shifting member 73 so that the first shifting member 73 cannot move up and down. Additionally, the first shifting member 73 is also restrained as a result of the wedge portion 731 being stopped by the wedge portion 741, and thus the first lock module 71 is restrained in a first position. In the meantime, based on the position of the first lock module 71, the second block 62 is pulled by the second strip 61 to move to be horizontally aligned with the first block 52. The object is finally locked because the first block 52 and the second block 62 cannot pass through the through hole 9 together.

Besides, as shown in FIG. 6, the first lock module 71 is engaged with a terminal of the hook portion 42 to form a loop when the first lock module 71 is located in the first position, thereby functioning as an another lock.

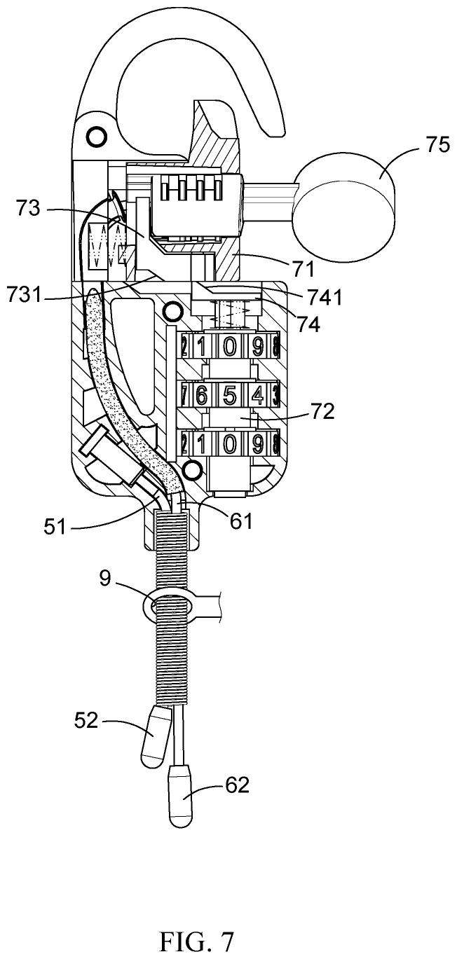

If the first lock module 71 is unlocked when the second lock module 72 is locked, or the lock core is turned by key 75 so that the corner 712 is turned toward the recess 733, allowing the first shifting member 73 to move up and down freely for the corner 712 to be received in the slot 733. Accordingly, referring to FIG. 7, since the second shifting member 74 is fixed in position, the first shifting member 73 can be pushed upward by the wedge portion 741 of the second shifting member 74 when the first lock module 71 is pushed. Furthermore, the first lock module 71 can move from the first position to a second position, and thus the second block 62 is pulled by the second strip 61 to move away from the first block 52. The object is finally unlocked because the first block 52 and the second block 62 can pass through the through hole 9 one after another.

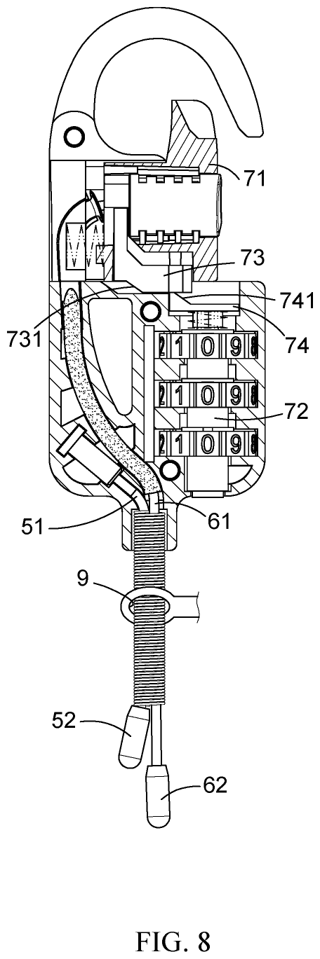

Referring to FIG. 8, if the second lock module 72 is unlocked, then whether the second lock module 72 is locked or not, the object is unlocked. The reason is that the second shifting member 74 is able to move up and down freely after the second lock module 72 is dialed to correct numbers, and therefore the second shifting member 74 can be pushed downward by the wedge portion 731 of the first shifting member 73 that is pushed to the left by the first lock module 71 which is pushed to the left, regardless of the locking state of the first lock module 71. Consequently, the first lock module 71 moves to the second position so that the second block 62 is pulled by the second strip 61 to move away from the first block 52. The object is finally unlocked because the first block 52 and the second block 62 can pass through the through hole 9 one after another.

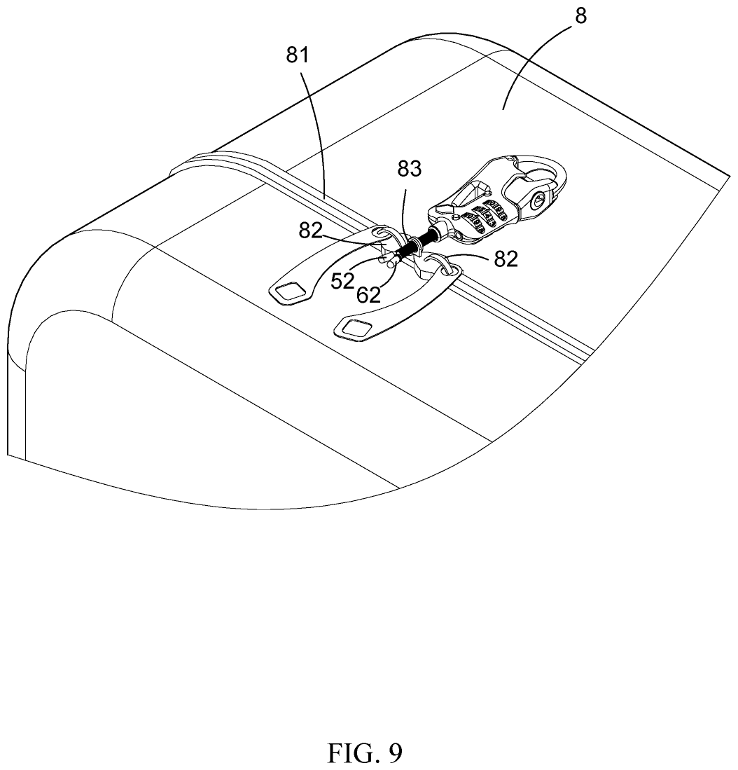

One of preferred embodiments according to the present invention is shown in FIG. 9. An opening of a suitcase 8 is provided with a zipper 81 having two zipper pulls 82, each zipper pull 82 having a through hole 83. By putting the first block 52 and the second block 62 separately through the through holes 83 of the two zipper pulls 82 and then switching to the lock state as previously described, the two zipper pulls 82 will not be detached from the present invention The two zipper pulls 82 will not be separated so as to prevent the suitcase 8 from being accidentally opened.

What is claimed is:

1. A lock comprising:
a housing;
a first lock member with one end secured to the housing and another end provided with a first block;
a second lock member with one end being provided with a second block; and
a control member disposed in the housing and coupled to the second lock member, wherein when the control member is selectively in a non-movable state, the control member is fixed in a first position and the second block is horizontally aligned with the first block, wherein when the control member is selectively in a movable state, the control member is capable of moving between the first position and a second position so as to stagger the first block and the second block.

2. The lock according to claim 1, wherein the control member includes a lock mechanism, the control member being fixed in the first position if the lock mechanism is locked, the control member being movable between the first position and the second position if the lock mechanism is unlocked.

3. The lock according to claim 1, wherein the control member includes a first lock module and a second lock module, the first lock module being coupled to the second lock member, wherein the first lock module which is unlocked is movable between the first position and the second position, wherein the first lock module which is locked is restrained by the second lock module to be fixed in the first position if the second lock module is locked, wherein the first lock module is movable between the first position and the second position if the second lock module is unlocked.

4. The lock according to claim 3, wherein a first shifting member and a second shifting member are disposed between the first lock module and the second lock module, a wedge portion of the first shifting member being movably engaged with a wedge portion of the second shifting member, the second shifting member being fixed when the second lock module is locked, wherein a mobility of the first shifting member is restrained by the first lock module and the second shifting member so that the first lock module is fixed in the first position if the first lock module is locked, wherein the first shifting member is capable of moving relative to the second shifting member so that the first lock module is capable of moving between the first position and the second position if the first lock module is unlocked, wherein the second shifting member is capable of moving relative to the first shifting member so that the first lock module is capable of moving between the first position and the second position if the second lock module is unlocked.

5. The lock according to claim 4, wherein the first lock module is a combination lock or a key lock.

6. The lock according to claim 4, wherein the second lock module is a combination lock or a key lock.

7. The lock according to claim 1, wherein the first lock member includes a first strip with one end secured to the housing and another end sticking out of the housing to connect the first block, wherein the second lock member includes a second strip with one end coupled to the control member and another end sticking out of the housing to connect the second block.

8. The lock according to claim 7, wherein both of the first strip and the second strip are flexible, and parts of both of the first strip and the second strip which stick out of the housing are covered by a sleeve, wherein each of the first block and the second block cannot pass through the sleeve.

9. The lock according to claim 1, wherein the housing is provided with a hook portion to be engaged with the control member and forming a loop when the control member is located in the first position.

10. A locking method applied to an object with a through hole comprising:
putting a first strip and a second strip through the through hole, wherein one end of the first strip is coupled to a first block while another end is fixed, and one end of the second strip is coupled to a second block while another end is controllable to pull the second strip and the second block, wherein each diameter of the first block and the second block is less than a diameter of the through hole, but a total width of the first block and the second block that are horizontally aligned is greater than the diameter of the through hole;
pulling the second strip to move the second block to horizontally align with the first block and then fastening the second strip, whereby locking the object; and
pulling the second strip to stagger the first block and the second block, whereby unlocking the object.
